(19) United States
(12) Patent Application Publication
(10) Pub. No.: US 2022/0292432 A1
(43) Pub. Date: Sep. 15, 2022

(54) METHOD AND SYSTEM FOR GENERATING TRAINING DATA FOR A MACHINE-LEARNING ALGORITHM

(71) Applicant: YANDEX EUROPE AG, Luzern (CN)

(72) Inventors: Valentin Andreevich BIRYUKOV, Orenburg (RU); Nikita Vitalevich PAVLICHENKO, Moscow (RU); Valentina Pavlovna FEDOROVA, Sergiev Posad (RU)

(21) Appl. No.: 17/575,962

(22) Filed: Jan. 14, 2022

(30) Foreign Application Priority Data
Mar. 15, 2021 (RU) 2021106660

(51) Int. Cl. G06Q 10/06; G06V 10/774

(52) U.S. Cl. CPC G06Q 10/063112; G06Q 10/0639; G06V 10/774

(57) ABSTRACT

A method and a system for generating training data for an MLA are provided. The method comprises: retrieving assessor data including data indicative of a plurality of results responsive to the given digital task having been submitted to a set of assessors; determining, for a given result, a number of instances thereof within the plurality of results; determining, a respective value of an aggerate quality metric associated with the given result; identifying a reliable result of the plurality of results as being associated with a maximum value of the aggregate quality metric; determining, based on the reliable result, updated quality scores for each one of the current set of assessors; generating, based on the respective updated quality score, an updated set of assessors; and generating the training data for the MLA including data generated in response to respective ones of the updated set of assessors completing a subsequent digital task.

### CROSS-REFERENCE

The present application claims priority to Russian Patent Application No. 2021106660, entitled “Method and System for Generating Training Data for a Machine-Learning Algorithm”, filed Mar. 15, 2021, the entirety of which is incorporated herein by reference.

### FIELD

The present technology relates to methods and systems for generating training data for a machine-learning algorithm (MLA); and more particularly, to methods and systems for determining quality scores of assessors for executing tasks for the generating the training data.

### BACKGROUND

Machine-learning algorithms (MLAs) require a large amount of labelled data for training. Crowdsourcing platforms, such as an Amazon Mechanical Turk™ crowdsourcing platform, allow obtaining labelled training data sets by assigning various digital tasks to assessors provided with instructions to complete the tasks. By doing so, the crowdsourcing platforms may allow obtaining the labelled training data sets in a shorter time as well as at a lower cost compared to that needed for the use of a limited number of experts.

However, it is known that the assessors, unlike the experts, are generally non-professional and vary in levels of expertise, and therefore the obtained labels are much noisier than those obtained from experts.

There are several known sources of noise in a crowd-sourced environment. For example, a most studied kind of noise appears in multi-classification tasks, where assessors can confuse classes. Another type of noise is the automated bots, or spammers, that execute as many tasks as possible to increase revenue, which may decrease the overall quality of a resulting training data set.

One of approaches to assessing quality of the assessors executing the tasks and thus controlling the level of noise in the resulting labelled training data set is based on control tasks (also referred to herein as “honey pots”), that is, certain proportion of the tasks with predetermined expected results. Thus, based on how a given assessor executes the control tasks, a respective quality score thereof may be determined for the given assessor. Further, based on the so determined quality scores of the assessors, the labels provided thereby may be adjusted—such as by assigning weights indicative of the respective quality scores of the assessors—which may allow reducing the level of noise in the resulting training data set.

However, such an approach may not be effective, as some of the assessors (also referred to herein as “fraudsters”) may learn to recognize the control tasks and may thus faithfully execute them, while executing other tasks with lesser dedication or accuracy. Further, generating and providing new control tasks to detect fraudulent labelling may result in the resulting labelled training data set significantly increasing in cost.

Certain prior art approaches have been proposed to tackle the above-identified technical problem of increasing the quality of training data for MLAs.

U.S. Patent Application Publication No.: 2017/046,794-A1 published on Feb. 16, 2017, assigned to Accenture Global Services Ltd., and entitled “System for Sourcing Talent Utilizing Crowdsourcing” discloses a system capable of obtaining a work request eligible for crowdsourcing and determine a work request type associated with the work request. The system may provide the work request to a group of talent devices. The system may assign the work request to one or more users associated with the group of talent devices based on the work request type. The system may obtain one or more deliverables associated with the work request and may validate the one or more deliverables based on the work request type. The system may obtain feedback information for the one or more deliverables. The system may generate a game score based on the feedback information and may provide the feedback information and the game score to one or more talent devices, of the group of talent devices, associated with the one or more users assigned to the work request.

The article “Software Crowdsourcing Task Allocation Algorithm Based on Dynamic Utility” written by Dunhui Yu Yi Wang and Zhuang Zhou, and published by Institute of Electrical and Electronics Engineers discloses a dynamic utility task allocation algorithm (DUTA), a software crowdsourcing task allocation algorithm based on the dynamic utility. First, using the attributes provided by the worker registration information, the initial value of a worker's development abilities is estimated based on the attribute weights and levels. Second, the worker's development capabilities are calculated based on his or her history of the completed tasks, including task complexity, quality, and development efficiency. The worker's record of development capability is updated dynamically. Then, based on the skill weights, the degree to which the task requirements match the worker's skills is calculated. Finally, the product of the worker's development ability and the degree of skill matching as the allocation utility is taken, and the total utility is maximized as the optimization goal. To solve the optimal match between tasks and workers, the Kuhn-Munkres algorithm with a weighted bipartite graph is used.

### SUMMARY

It is an object of the present technology to ameliorate at least one inconvenience present in the prior art.

Developers of the present technology have appreciated that the overall quality of the resulting labelled training data set may be increased if the respective quality scores of the assessors could be determined without using the control tasks. More specifically the developers have realized that a reliable result, likely to be the correct one, for a given task may be determined based on a number of instances of each result amongst all the results provided by the assessors for the given task and the respective quality scores of the assessors.

Further, the developers have appreciated that the respective quality scores of the assessors may be updated prior to executing a following task, based on the so determined reliable result. For example, the crowdsourcing platform may be configured to increase respective quality scores of those assessors whose results corresponded to the reliable one and decrease respective quality scores of those having provided results that do not correspond to the reliable result. Further, the crowdsourcing platform may be configured to assign the following task to assessors having respective updated quality scores meeting a predetermined condition—such as being greater than a predetermined threshold.

Thus, certain non-limiting embodiments of the present technology are directed to determining a set of assessors that may further provide execution of the tasks at an expected accuracy level. Further, the methods and systems described herein may allow decreasing respective quality scores of assessors systematically providing fraudulent results, which may further allow preventing such assessors from being considered for completing following tasks. Hence, the present methods and systems allow learning the respective quality scores of the assessors based on the executed tasks without having to apply the control tasks for assessing the performance of the assessors, which may translate in higher quality of the training data for the MLAs avoiding increased costs potentially caused by applying the control tasks.

More specifically, in accordance with a first broad aspect of the present technology, there is provided a computer-implemented method of generating training data for a computer-executable Machine Learning Algorithm (MLA). The training data is based on digital tasks accessible by a current set of assessors. The method is executable at a server including a processor accessible, over a communication network, by electronic devices associated with the current set of assessors. The method comprises: retrieving, by the processor, assessor data associated with the current set of assessors, the assessor data being indicative of past performance of respective ones of the current set of assessors completing a given digital task, the assessor data including: data indicative of a plurality of results responsive to the given digital task having been submitted to the current set of assessors; and data indicative of respective current quality scores of each one of the current set of assessors; determining, by the processor, for a given result of the plurality of results, a number of instances thereof within the plurality of results; determining, based on the number of instances and respective current quality scores of those of the current set of assessors having provided the given result, a respective value of an aggerate quality metric associated with the given result; identifying, by the processor, a reliable result of the plurality of results as being associated with a maximum value of the aggregate quality metric; determining, based on the reliable result, updated quality scores for each one of the current set of assessors, such that: in response to a given one of the current set of assessors having provided a respective result corresponding to the reliable result, increasing a respective current quality score associated with the given one of the current set of assessors by a predetermined value; and in response to the given one of the current set of assessors having provided the respective result not corresponding to the reliable result, decreasing the respective current quality score by the predetermined value; in response to a respective updated quality score associated with the given one of the current set of assessors being greater than or equal to a predetermined quality score threshold, including the given one of the current set of assessors in an updated set of assessors; transmitting, by the processor, a subsequent digital task to be completed to electronic devices associated with the updated set of assessors; and generating, by the processor, the training data for the computer-executable MLA including data generated in response to respective ones of the updated set of assessors completing the subsequent digital task.

In some implementations of the method, the determining the respective value of the aggregate quality metric associated with the given result is executed in accordance with an equation:

S(y)=Σᵢ₌₁ⁿskillᵢ·I(yᵢ=y),

where S(y) is the respective value of the aggregate quality metric,
I(yᵢ=y) is a given instance of the given result, and
skillᵢ is a given one of the respective current quality scores of those of the current set of assessors having provided the given result.

In some implementations of the method, the respective current quality score is indicative of a likelihood value of executing the given digital task by the given one of the current set of assessors correctly, and the determining the aggregate quality metric comprises determining an expected value of the given result in accordance with an equation:

$$𝔼 ( y ) = {\sum }_{i = 1}^{n} {skill}_{i} \cdot I ( {y}_{i} = y ) + {\sum }_{i = 1}^{n} \frac{1 - {skill}_{i}}{L - 1} \cdot I ( {y}_{i} \neq y ) ,$$

where I(yᵢ=y) is a given instance of the given result;
skillᵢ is a given one of the respective current quality scores of those of the current set of assessors having provided the given result;
I(yᵢ≠y) is a given instance of an other one of the plurality of results, which is different form the given result; and
L is a number of instances of the other one of the plurality of results different from the given result.

In some implementations of the method, the method further comprises determining the predetermined value for one of increasing and decreasing the respective current quality score based on a difference between the respective current quality score of the given one of the current set of assessors and a binary mask value, the binary mask value being 1 if the given result corresponds to the reliable result, and being 0 if the given result does not correspond to the reliable result.

In some implementations of the method, the determining the predetermined value is further based on a predetermined multiplicative coefficient indicative of a penalizing rate for each one of the current set of assessors having provided results different from the reliable result.

In some implementations of the method, determining the respective updated quality score is executed in accordance with an equation:

skill_{i,t}←skill_{i,t-1}+λdᵢ,

where skill_{i,t} is the respective updated quality score of the given one of the current set of assessors;
skill_{i,t-1} is the respective current quality score of the given one of the current set of assessors;
dᵢ is the difference between the respective current quality score and a binary value indicative of the given result provided thereby corresponding to the reliable result or not; and
λ is the predetermined multiplicative coefficient.

In some implementations of the method, the determining the respective updated quality score further comprises, for the given one of the current set of assessors, for a given last past digital task of a series of past digital tasks, the series of past digital tasks having been determined using a sliding window of a predetermined width, determining the respective updated quality score based on a last quality score associated with the given last past digital tasks and other quality scores of a remainder ones of the series of past digital tasks.

In some implementations of the method, the determining the respective updated quality score is executed in accordance with an equation:

$${skill}_{i , t} ← \frac{{\sum }_{j = t - w + 1}^{t} {skill}_{i , j}}{w} ,$$

where skill_{i,t} is the respective updated quality score associated with the given one of the current set of assessors,
skill_{i,j} is the given one of the past quality scores associated with the given one of the current set of assessors, determined based on the given one of the current set of assessors completing the respective one of the series of past digital tasks; and
w is the predetermined width of the sliding window indicative of a number of past digital tasks in the series of the past digital tasks.

In some implementations of the method, the respective current quality score has been determined based on accuracy of the given one of the current set of assessors completing a control digital task.

In some implementations of the method, the method further comprises: retrieving, by the processor, data including a plurality of subsequent results responsive to the subsequent digital task having been submitted to the updated set of assessors determining, by the processor, for a given subsequent result of the plurality of subsequent results, a second number of instances of the given subsequent result within the plurality of subsequent results; determining, based on the second number of instances and respective updated quality scores of those of the updated set of assessors having provided the given subsequent result, a respective value of a second aggerate quality metric associated with the given subsequent result; and identifying, by the processor, a reliable subsequent result of the plurality of subsequent results as being associated with a maximum value of the second aggregate quality metric.

In some implementations of the method, the method further comprises determining, based on the reliable subsequent result, newly updated quality scores for each one of the updated set of assessors, such that: in response to a given one of the updated set of assessors having provided a respective subsequent result corresponding to the reliable subsequent result, increasing a respective updated quality score associated with the given one of the updated set of assessors by the predetermined value; and in response to the given one of the updated set of assessors having provided the respective subsequent result not corresponding to the reliable subsequent result, decreasing the respective updated quality score by the predetermined value; in response to a newly updated quality score associated with the given one of the updated set of assessors being greater than or equal to the predetermined quality score threshold, including the given one of the updated set of assessors in a newly updated set of assessors; transmitting, by the processor, an other subsequent digital task to be completed to electronic devices associated with the newly updated set of assessors; and generating, by the processor, the training data for the computer-executable MLA including data generated in response to respective ones of the newly updated set of assessors completing the other subsequent digital task.

In some implementations of the method, the determining the newly updated quality scores for each one of the updated set of assessors for determining the newly updated set of assessors is triggered by receipt, by the server, the other subsequent digital task.

In accordance with a second broad aspect of the present technology, there is provided a system for generating training data for a computer-executable Machine Learning Algorithm (MLA). The training data is based on digital tasks accessible by a current set of assessors. The system comprising a server including: a processor accessible, over a communication network, by electronic devices associated with the current set of assessors and a non-transitory computer-readable memory storing instructions. The processor, upon executing the instructions, is configured to: retrieve assessor data associated with the current set of assessors, the assessor data being indicative of past performance of respective ones of the current set of assessors completing a given digital task, the assessor data including: data indicative of a plurality of results responsive to the given digital task having been submitted to the current set of assessors; and data indicative of respective current quality scores of each one of the current set of assessors; determine, for a given result of the plurality of results, a number of instances thereof within the plurality of results; determine, based on the number of instances and respective current quality scores of those of the current set of assessors having provided the given result, a respective value of an aggerate quality metric associated with the given result; identify a reliable result of the plurality of results as being associated with a maximum value of the aggregate quality metric; determine, based on the reliable result, updated quality scores for each one of the current set of assessors, such that: in response to a given one of the current set of assessors having provided a respective result corresponding to the reliable result, increase a respective current quality score associated with the given one of the current set of assessors by a predetermined value; and in response to the given one of the current set of assessors having provided the respective result not corresponding to the reliable result, decrease the respective current quality score by the predetermined value; in response to a respective updated quality score associated with the given one of the current set of assessors being greater than or equal to a predetermined quality score threshold, include the given one of the current set of assessors in an updated set of assessors; transmit a subsequent digital task to be completed to electronic devices associated with the updated set of assessors; and generate the training data for the computer-executable MLA including data generated in response to respective ones of the updated set of assessors completing the subsequent digital task.

In some implementations of the system, the processor is configured to determine the respective value of the aggregate quality metric associated with the given result in accordance with an equation:

S(y)=Σᵢ₌₁ⁿskillᵢ·I(yᵢ=y),

where S(y) is the respective value of the aggregate quality metric,
I(yᵢ=y) is a given instance of the given result, and
skillᵢ is a given one of the respective current quality scores of those of the current set of assessors having provided the given result.

In some implementations of the system, the respective current quality score is indicative of a likelihood value of executing the given digital task by the given one of the current set of assessors correctly, and the processor is configured to determine the aggregate quality metric as an expected value of the given result in accordance with an equation:

$$𝔼 ( y ) = {\sum }_{i = 1}^{n} {skill}_{i} \cdot I ( {y}_{i} = y ) + {\sum }_{i = 1}^{n} \frac{1 - {skill}_{i}}{L - 1} \cdot I ( {y}_{i} \neq y ) ,$$

where I(yᵢ=y) is a given instance of the given result;
skillᵢ is a given one of the respective current quality scores of those of the current set of assessors having provided the given result;
I(yᵢ≠y) is a given instance of an other one of the plurality of results, which is different form the given result; and
L is a number of instances of the other one of the plurality of results different from the given result.

In some implementations of the system, the processor is further configured to determine the predetermined value for one of increasing and decreasing the respective current quality score based on a difference between the respective current quality score of the given one of the current set of assessors and a binary mask value, the binary mask value being 1 if the given result corresponds to the reliable result, and being 0 if the given result does not correspond to the reliable result.

In some implementations of the system, the processor is further configured to determine the predetermined value based on a predetermined multiplicative coefficient indicative of a penalizing rate for each one of the current set of assessors having provided results different from the reliable result.

In some implementations of the system, the processor is configured to determine the respective updated quality score in accordance with an equation:

skill_{i,t}←skill_{i,t-1}+λdᵢ,

where skill_{i,t} is the respective updated quality score of the given one of the current set of assessors;
skill_{i,t-1} is the respective current quality score of the given one of the current set of assessors;
dᵢ is the difference between the respective current quality score and a binary value indicative of the given result provided thereby corresponding to the reliable result or not; and
λ is the predetermined multiplicative coefficient.

In some implementations of the system, to determine the respective updated quality score, the processor is further configured, for the given one of the current set of assessors, for a given last past digital task of a series of past digital tasks, the series of past digital tasks having been determined using a sliding window of a predetermined width, to determine the respective updated quality score based on a last quality score associated with the given last past digital tasks and other quality scores of a remainder ones of the series of past digital tasks.

In some implementations of the system, the processor is further configured to determine the respective updated quality score in accordance with an equation:

$${skill}_{i , t} ← \frac{{\sum }_{j = t - w + 1}^{t} {skill}_{i , j}}{w} ,$$

where skill_{i,t} is the respective updated quality score associated with the given one of the current set of assessors,
skill_{i,j} is the given one of the past quality scores associated with the given one of the current set of assessors, determined based on the given one of the current set of assessors completing the respective one of the series of past digital tasks; and
w is the predetermined width of the sliding window indicative of a number of past digital tasks in the series of the past digital tasks.

In the context of the present specification, a “server” is a computer program that is running on appropriate hardware and is capable of receiving requests (e.g., from client devices) over a network, and carrying out those requests, or causing those requests to be carried out. The hardware may be one physical computer or one physical computer system, but neither is required to be the case with respect to the present technology. In the present context, the use of the expression a “server” is not intended to mean that every task (e.g., received instructions or requests) or any particular task will have been received, carried out, or caused to be carried out, by the same server (i.e., the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “at least one server”.

In the context of the present specification, “client device” is any computer hardware that is capable of running software appropriate to the relevant task at hand. Thus, some (non-limiting) examples of client devices include personal computers (desktops, laptops, netbooks, etc.), smartphones, and tablets, as well as network equipment such as routers, switches, and gateways. It should be noted that a device acting as a client device in the present context is not precluded from acting as a server to other client devices. The use of the expression “a client device” does not preclude multiple client devices being used in receiving/sending, carrying out or causing to be carried out any task or request, or the consequences of any task or request, or steps of any method described herein.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers.

In the context of the present specification, the expression “information” includes information of any nature or kind whatsoever capable of being stored in a database. Thus information includes, but is not limited to audiovisual works (images, movies, sound records, presentations, etc.), data (location data, numerical data, etc.), text (opinions, comments, questions, messages, etc.), documents, spreadsheets, lists of words, etc.

In the context of the present specification, the expression “component” is meant to include software (appropriate to a particular hardware context) that is both necessary and sufficient to achieve the specific function(s) being referenced.

In the context of the present specification, the expression “computer usable information storage medium” is intended to include media of any nature and kind whatsoever, including RAM, ROM, disks (CD-ROMs, DVDs, floppy disks, hard drivers, etc.), USB keys, solid state-drives, tape drives, etc.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first server” and “third server” is not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 depicts a schematic diagram of an example computer system for implementing certain non-limiting embodiments of systems and/or methods of the present technology;

FIG. 2 depicts a networked computing environment configurable for generating training data for training a machine-learning algorithm (MLA), in accordance with certain non-limiting embodiments of the present technology;

FIG. 3 depicts a schematic diagram of an interface of a crowdsourcing application run on a server present in the networked computing environment of FIG. 2 for executing an example digital task by one of assessors, in accordance with certain non-limiting embodiments of the present technology;

FIG. 4 depicts a schematic diagram of a process for updating, by the server present in the networked computing environment of FIG. 2, respective quality scores of a current set of assessors executing a given digital task in the networked computing environment of FIG. 2, in accordance with certain non-limiting embodiments of the present technology;

FIG. 5 depicts a schematic diagram of a process for determining, by the server present in the networked computing environment of FIG. 2, an average value of a respective quality score of a given one of the current set of assessors executing the given digital task in the networked computing environment of FIG. 2, in accordance with certain non-limiting embodiments of the present technology;

FIG. 6 depicts a schematic diagram of a process for determining, by the server present in the networked computing environment of FIG. 2, further sets of assessors for executing subsequent digital tasks for generating the training data for training the MLA, in accordance with certain non-limiting embodiments of the present technology; and

FIG. 7 depicts a flowchart of a method for generating, by the server present in the networked computing environment of FIG. 2, training data for training an MLA, in accordance with certain non-limiting embodiments of the present technology.

### DETAILED DESCRIPTION

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a “processor” or a “graphics processing unit,” may be provided through the use of dedicated hardware as well as hardware capable of executing software in association with appropriate software. When provided by a processor, the functions may be provided by a single dedicated processor, by a single shared processor, and/or by a plurality of individual processors, some of which may be shared. In some embodiments of the present technology, the processor may be a general-purpose processor, such as a central processing unit (CPU) or a processor dedicated to a specific purpose, such as a graphics processing unit (GPU). Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random-access memory (RAM), and/or non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown.

With these fundamentals in place, we will now consider some non-limiting examples to illustrate various implementations of aspects of the present technology.

### Computer System

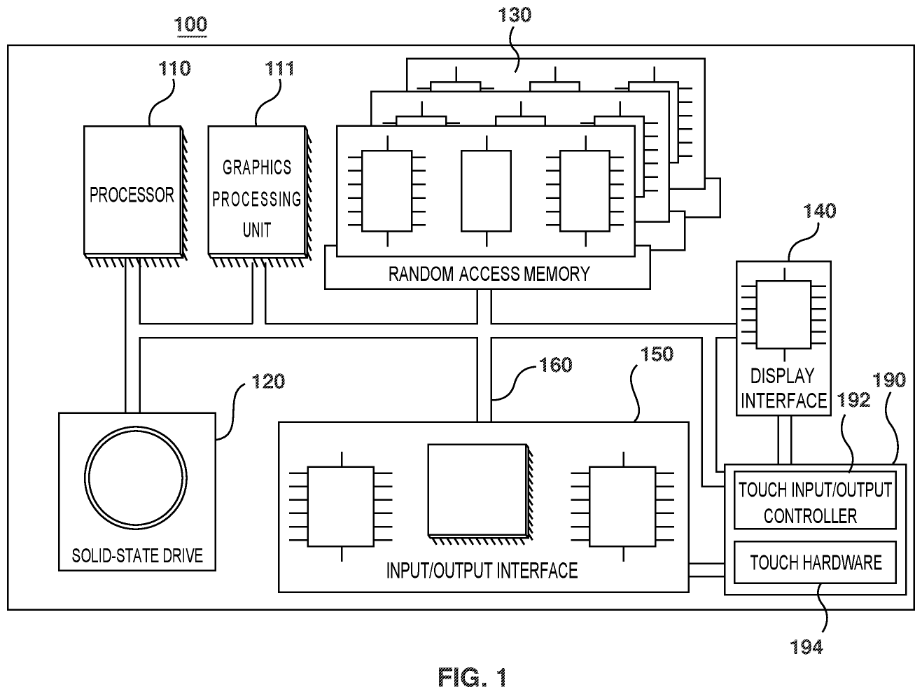

With reference to FIG. 1, there is depicted a computer system 100 suitable for use with some implementations of the present technology. The computer system 100 comprises various hardware components including one or more single or multi-core processors collectively represented by a processor 110, a graphics processing unit (GPU) 111, a solid-state drive 120, a random-access memory 130, a display interface 140, and an input/output interface 150.

Communication between the various components of the computer system 100 may be enabled by one or more internal and/or external buses 160 (e.g. a PCI bus, universal serial bus, IEEE 1394 “Firewire” bus, SCSI bus, Serial-ATA bus, etc.), to which the various hardware components are electronically coupled.

The input/output interface 150 may be coupled to a touchscreen 190 and/or to the one or more internal and/or external buses 160. The touchscreen 190 may be part of the display. In some non-limiting embodiments of the present technology, the touchscreen 190 is the display. The touchscreen 190 may equally be referred to as a screen 190. In the embodiments illustrated in FIG. 1, the touchscreen 190 comprises touch hardware 194 (e.g., pressure-sensitive cells embedded in a layer of a display allowing detection of a physical interaction between a user and the display) and a touch input/output controller 192 allowing communication with the display interface 140 and/or the one or more internal and/or external buses 160. In some embodiments, the input/output interface 150 may be connected to a keyboard (not shown), a mouse (not shown) or a trackpad (not shown) allowing the user to interact with the computer system 100 in addition to or instead of the touchscreen 190.

It is noted that some components of the computer system 100 can be omitted in some non-limiting embodiments of the present technology. For example, the touchscreen 190 can be omitted, especially (but not limited to) where the computer system is implemented as a server.

According to implementations of the present technology, the solid-state drive 120 stores program instructions suitable for being loaded into the random-access memory 130 and executed by the processor 110 and/or the GPU 111. For example, the program instructions may be part of a library or an application.

### Networked Computing Environment

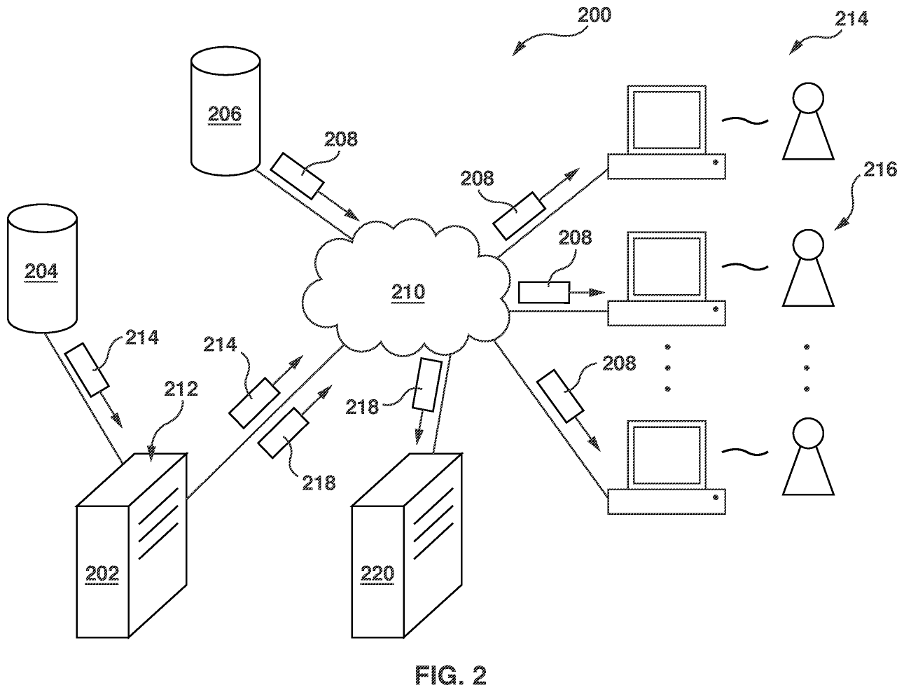

With reference to FIG. 2, there is depicted a schematic diagram of a networked computing environment 200 suitable for use with some non-limiting embodiments of the systems and/or methods of the present technology. The networked computing environment 200 comprises a server 202 and an assessor database 204 communicatively coupled with the server 202 over a respective communication link.

According to certain non-limiting embodiments of the present technology, the assessor database 204 may comprise an indication of identities of a plurality of assessors (such as human assessors) available for completing at least one digital task (also referred to herein as a “human intelligence task (HIT)”, a crowd-sourced task, or simply, a task) and/or who have completed at least one digital task in the past and/or registered for completing at least one digital task. Further, in some non-limiting embodiments of the present technology, the assessor database 204 may also store assessor data associated with the plurality of assessors including, for example, without limitation, sociodemographic parameters of each one of the plurality of assessors; data indicative of past performance of each one of the plurality of assessors; parameters indicative of accuracy of completing digital tasks associated with each one of the plurality of assessors—such as respective quality scores, as will be described in more detail below.

In some non-limiting embodiments of the present technology, the assessor database 204 can be under control and/or management of a provider of crowd-sourced services, such as Yandex LLC of Lev Tolstoy Street, No. 16, Moscow, 119021, Russia. In alternative non-limiting embodiments of the present technology, the assessor database 204 can be operated by a different entity.

The implementation of the assessor database 204 is not particularly limited and, as such, the assessor database 204 could be implemented using any suitable known technology, as long as the functionality described in this specification is provided for. Also, it should be noted that, in alternative non-limiting embodiments of the present technology, the assessor database 204 can be coupled to the server 202 over a communication network 210.

It is contemplated that the assessor database 204 can be stored at least in part at the server 202 and/or be managed at least in part by the server 202. In accordance with the non-limiting embodiments of the present technology, the assessor database 204 comprises sufficient information associated with the identity of at least some of the plurality of assessors to allow an entity that has access to the assessor database 204, such as the server 202, to assign and transmit one or more digital tasks to be completed by the one or more assessors.

In some non-limiting embodiments of the present technology, the server 202 can be implemented as a conventional computer server and may thus comprise some or all of the components of the computer system 100 of FIG. 1. As a non-limiting example, the server 202 can be implemented as a Dell™ PowerEdge™ Server running the Microsoft™ Windows Server™ operating system. Needless to say, the server 202 can be implemented in any other suitable hardware and/or software and/or firmware or a combination thereof. In the depicted non-limiting embodiment of the present technology, the server 202 is a single server. In alternative non-limiting embodiments of the present technology, the functionality of the server 202 may be distributed and may be implemented via multiple servers.

In some non-limiting embodiments of the present technology, the server 202 can be operated by the same entity that operates the assessor database 204. In alternative non-limiting embodiments of the present technology, the server 202 can be operated by an entity different from the one that operates the assessor database 204.

In some non-limiting embodiments of the present technology, the server 202 may configured to execute a crowdsourcing application 212. For example, the crowdsourcing application 212 may be implemented as a crowdsourcing platform such as Yandex.Toloka™ crowdsourcing platform, or other proprietary or commercially available crowdsourcing platform.

To that end, according to certain non-limiting embodiments of the present technology, the server 202 may be communicatively coupled, via the communication network 210, to a task database 206. In alternative non-limiting embodiments, the task database 206 may be coupled to the server 202 via a direct communication link. Although the task database 206 is illustrated schematically herein as a single entity, it is contemplated that the task database 206 may be implemented in a distributed manner.

The task database 206 is populated with digital tasks to be executed by at least some of the plurality of assessors. How the task database 206 is populated with the tasks is not limited. Generally speaking, one or more task requesters (not separately depicted) may submit one or more tasks to be stored in the task database 206. In some non-limiting embodiments of the present technology, the one or more task requesters may specify the type of assessors the task is destined to, and/or a budget to be allocated to each one of the plurality of assessors providing a result.

For example, a given task requestor may have submitted, to the task database 206, a given digital task 208; and the server 202 may be configured to retrieve the given digital task 208 from the task database 206 and determine, for example, based on instructions provided by the given task requestor, a current set of assessors 214 from the plurality of assessors. Further, the server 202 may be configured to submit the given digital task 208 to the current set of assessors 214 by transmitting the given digital task 208, via the communication network 210, to respective electronic devices (not separately labelled) of the current set of assessors 214.

According to various non-limiting embodiments of the present technology, a respective electronic device associated with a given assessor 216 of the current set of assessors 214 may be a device including hardware running appropriate software suitable for executing a relevant task at hand (such as the given digital task 208), including, without limitation, one of a personal computer, a laptop, an a smartphone, as an example. To that end, the respective electronic device may include some or all the components of the computer system 100 depicted in FIG. 1.

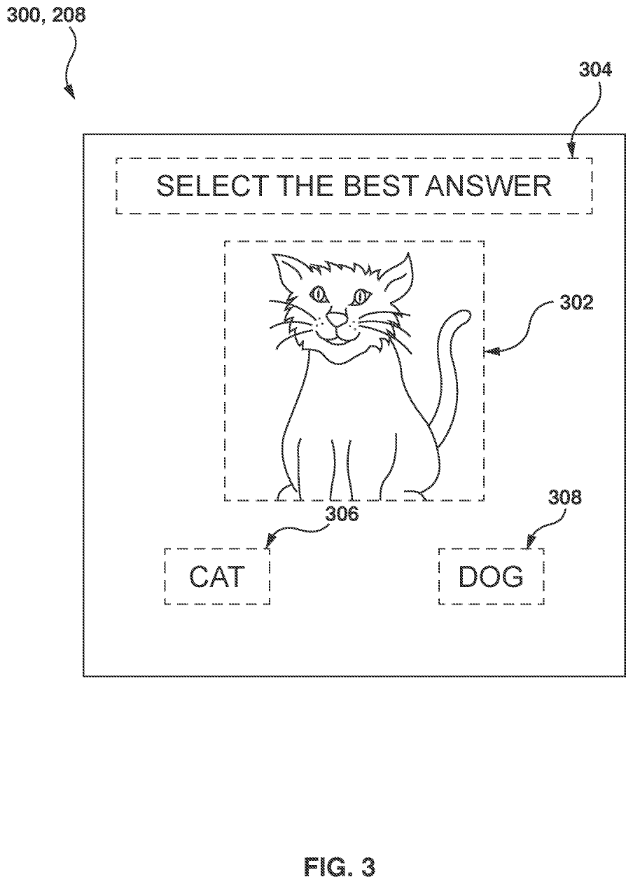

In some non-limiting embodiments of the present technology, the given digital task 208, stored in the task database 206, may be a classification task. As it can be appreciated, a classification task corresponds to a task in which a given one of the plurality of assessors is provided with a piece of data to be classified according to a plurality of provided classification options. With reference to FIG. 3, there is schematically depicted a screen shot of a crowdsourcing interface 300 of the crowdsourcing application 212 for completion of an example classification task, in accordance with certain non-limiting embodiment, of the present technology. The crowdsourcing interface 300 is depicted in FIG. 3 as it may be displayed on a screen of one of the respective electronic devices of the current set of assessors 214, as an example.

The crowdsourcing interface 300 illustrates an image 302 along with instructions 304 to the given one of the plurality of assessors to select one from at least two respective labels, best corresponding to the image 302: a first label 306 associated with one class (that is, “CAT”, for example) and a second label 308 associated with an other class (that is, “DOG”, for example). Thus, the given one of the plurality of assessors, based on perception thereof, selects one of the first label 306 and the second label 308, thereby assigning a respective class to the image 302. It should be noted that other types of classification tasks are contemplated, such as the classification of text documents, audio files, video files, and the like.

Also, although in the example of FIG. 3, the instructions 304 provide a binary choice—that is, selection out of the first label 306 and the second label 308, it should be expressly understood that other formats of the instructions 304 may be used, such as a scale of “1” to “5”, where “1” corresponds to one class, and “5” corresponds to the other class; or a scale of “1” to “10”, where “1” corresponds to the one class, and “10” corresponds to the other class, as an example. In other non-limiting embodiments of the present technology, the instructions 304 may provide a multiple-choice scale, where each value thereof is associated with a different class.

It should be noted that the given digital task 208, stored in the task database 206, can be of a type different that the classification task, for example, indicating a relevance parameter of a document to a search query (i.e. a regression task) and the like.

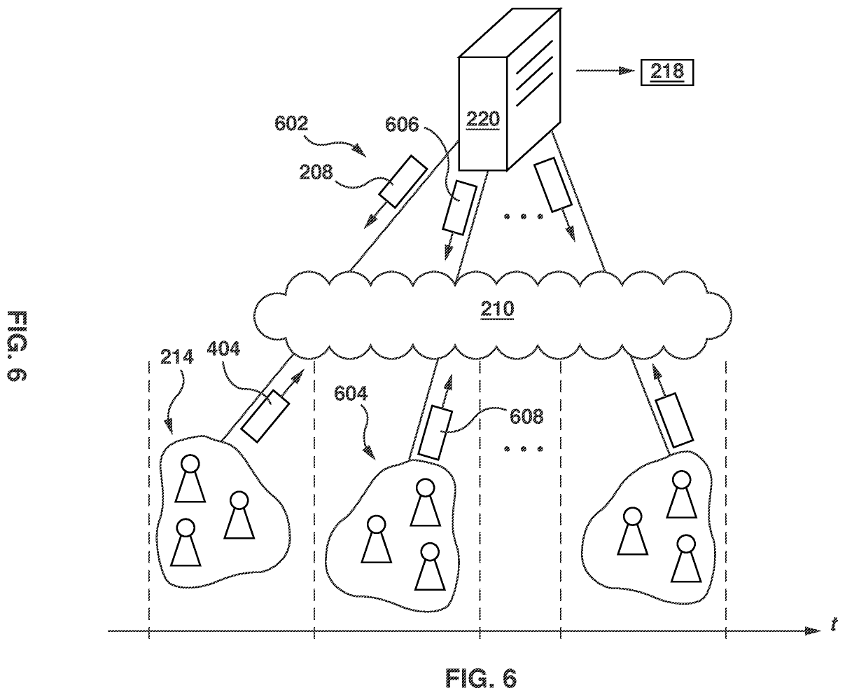

Referring back to FIG. 2, in some non-limiting embodiments of the present technology, the given digital task 208 may thus be submitted, by the given requester, to the task database 206, for example, for generating training data used for training a machine-learning algorithm (MLA) run by a third-party server 220 associated with the given task requestor. Needless to say, the third-party server 220 may be implemented in a fashion similar to the server 202, as described above. To that end, in some non-limiting embodiments of the present technology, the given digital task 208 may be one of a plurality of digital tasks (such as a plurality of digital tasks 602 depicted in FIG. 6) including, for example, hundreds, thousands, or even hundreds of thousands classification digital tasks similar to the given digital task 208, which the server 202 may be configured to submit for execution to generate a labelled training data set 218 for training the MLA run on the third-party server 220.

In some non-limiting embodiments of the present technology, the MLA may be based on neural networks (NN), convolutional neural networks (CNN), decision tree models, gradient boosted decision tree based MLA, association rule learning based MLA, Deep Learning based MLA, inductive logic programming based MLA, support vector machines based MLA, clustering based MLA, Bayesian networks, reinforcement learning based MLA, representation learning based MLA, similarity and metric learning based MLA, sparse dictionary learning based MLA, genetic algorithms based MLA, and the like. without departing from the scope of the present technology.

Further, the server 202 may be configured to transmit, over the communication network 210, the labelled training data set 218 to the third-party server 220. Thus, during a training phase, the third-party server 220 may be configured to train, based on the labelled training data set 218, the MLA to learn specific features, which may further be used, during an in-use phase, to classify input data, which may include, depending on the plurality of digital tasks, without limitation, images, audio files, video files, text documents, and the like.

In one example, where the third-party server 220 is a search engine server of a search engine application (such as a Yandex™ search engine application, a Google™ search engine application, and the like), the so trained MLA may be used to execute classification tasks for providing search engine result pages (SERPs) better responsive to user requests. In another example, where the third-party server 220 is a server providing control to a self-driving car, the so trained MLA may be used to detect and recognize objects within scenes registered by sensors of the self-driving car. In yet other example, where the third-party server 220 is a server of a virtual assistant application (such as a Yandex™ ALISA™ virtual assistant application, as an example), the so trained MLA may be used for recognizing user utterances within audio signals generated by a virtual assistant device executing the virtual assistant application. Other applications of the MLA trained based on the labelled training data set 218 as described above can also be envisioned without departing from the scope of the present technology.

Further, as it can be appreciated, overall quality of the labelled training set generally depends on how accurately each one of the current set of assessors 214 completes each one of the plurality of digital tasks, and may thus depend on respective quality scores of each one of the current set of assessors 214. Broadly speaking, a respective quality score associated with the given assessor 216 of the current set of assessors 214, as used herein, may be defined as a measure of quality of results the given assessor 216 provides when completing digital tasks assigned thereto by the server 202. For example, the respective quality score may be indicative, directly or indirectly, of a level of experience and/or expertise of the given assessor 216. In other words, the respective quality score of the given assessor 216 can be said to be indicative of a likelihood value of the given assessor 216 completing a digital task correctly—such as selecting, using the respective electronic device, a correct one of the first label 306 over the second label 308 in the example of FIG. 3.

In some non-limiting embodiments of the present technology, the respective quality score of the given assessor 216 may have values from 0 to 1, where 0 is the lowest value, and 1 is the highest one. However, other scales and formats of representing values of the respective quality score of the given assessor 216 are also envisioned without departing from the scope of the present technology.

In some non-limiting embodiments of the present technology, the server 202 may be configured to determine the respective quality score of the given assessor 216 based on control digital tasks with pre-associated correct results (so called “honey pots”) submitted to the given assessor 216 from time to time (or at a predetermined frequency) to assess accuracy of provided results.

However, some of the current set of assessors 214 (also known as “fraudsters”) may learn to identify the control digital tasks and provide correct results thereto to maintain a relatively high respective quality score, while completing other tasks negligibly, providing thereto fraudulent results of lower quality. This may induce noise to the labelled training data set 218 resulting in a lower quality thereof. The problem can further be exacerbated by the fact that, in such a case, identifying the fraudsters in a timely manner can be challenging as it may require developing new control digital tasks.

Thus, certain non-limiting embodiments of the present technology are directed to updating the respective quality scores of the given assessor 216 of the current set of assessors 214 considering the following parameters: (1) a current value of the respective quality score of the given assessor 216; and (2) a number of instances of each result among all results provided by the current set of assessors 214. By so doing, the methods and systems described herein may allow for automatic identification, and further banning, of assessors systematically providing fraudulent results without the need for developing new control digital tasks, which may further allow for higher efficiency of generating the labelled training data set 218.

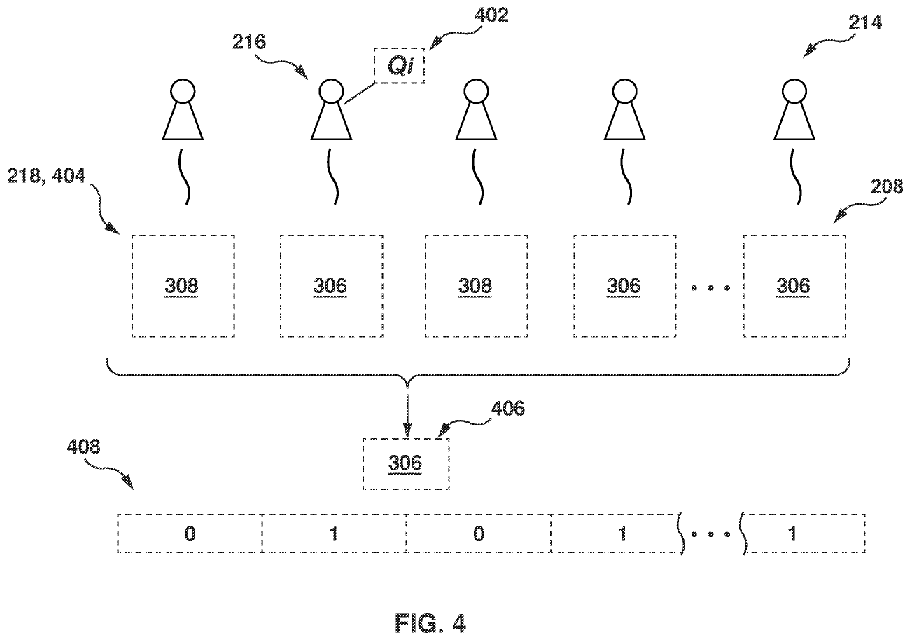

How the server 202 can be configured to update the respective quality scores of each one of the current set of assessors 214, in accordance with certain non-limiting embodiments of the present technology, will be described below with reference to FIGS. 4 to 6.

### Communication Network

In some non-limiting embodiments of the present technology, the communication network 210 is the Internet. In alternative non-limiting embodiments of the present technology, the communication network 210 can be implemented as any suitable local area network (LAN), wide area network (WAN), a private communication network or the like. It should be expressly understood that implementations for the communication network are for illustration purposes only. How a respective communication link (not separately numbered) between each one of the server 202, the assessor database 204, the task database 206, the third-party server 220, each one of electronic devices of the current set of assessors 214, and the communication network 210 is implemented will depend, inter alia, on how each one of each one of the server 202, the assessor database 204, the task database 206, the third-party server 220, and the electronic devices associated with the current set of assessors 214 is implemented. Merely as an example and not as a limitation, in those embodiments of the present technology where a given one of the electronic devices of the current set of assessors 214 includes a wireless communication device, the communication link can be implemented as a wireless communication link. Examples of wireless communication links include, but are not limited to, a 3G communication network link, a 4G communication network link, and the like. The communication network 210 may also use a wireless connection with the server 202 and the task database 206.

### Determining Updated Quality Scores

As noted hereinabove, in some non-limiting embodiments of the present technology, the server 202 may be configured to (1) receive, from the assessor database 204, indication of identities of the current set of assessors 214 for completing the given digital task 208; (2) receive assessors data of past performance of each one of the current set of assessors 214 including current values of the respective quality scores associated therewith; and (3) update the respective quality scores of each one of the current set of assessors 214 based on how they have completed the given digital task 208.

With reference to FIG. 4, there is depicted a schematic diagram of a process for updating, by the server 202, the respective quality scores of the current set of assessors 214, in accordance with certain non-limiting embodiments of the present technology.

Thus, as best shown in FIG. 4, the server 202 may be configured to retrieve a current value 402 Qᵢ of the respective quality score associated with the given assessor 216 of the current set of assessors 214. Further, the server 202 may be configured to submit the given digital task 208 to each one of the current set of assessors 214 for completion by transmitting an indication of the given digital task 208 to the respective electronic devices thereof over the communication network 210, as described above.

Hence, in some non-limiting embodiments of the present technology, the server 202 may be configured to receive a plurality of results 404 from each one of the current set of assessors 214. The plurality of results 404 may thus be used for generating the labelled training data set 218. As it can be appreciated from FIG. 4, each one of the plurality of results 404 includes an instance of one of the first label 306 and the second label 308 selected by a respective one of the current set of assessors 214 when completing the given digital task 208.

According to certain non-limiting embodiments of the present technology, the server 202 may be configured to determine, based on the plurality of results 404, a reliable result 406. Further, based on the reliable result 406, the server 202 may be configured to update the respective quality scores of the current set of assessors 214.

Broadly speaking, in the context of the present specification, the term “reliable result” denotes a result among the plurality of results 404 of completing the given digital task 208 that is likely to be correct. In some non-limiting embodiments of the present technology, the server 202 may be configured to determine the reliable result 406 based on a number of instances of each one of the first label 306 and the second label 308 and current values of the respective quality scores of those of the current set of assessors 214 having selected them.

To that end, in some non-limiting embodiments of the present technology, the server 202 may be configured to determine a respective value of an aggregate quality metric for each one of the first label 306 and the second label 308. Broadly speaking, the respective value of the aggregate quality metric associated with a given one of the first label 306 and the second label 308 can be said to be indicative of an aggregate quality score of those of the current set of assessors 214 having selected the given one of the first label 306 and the second label 308 when executing the given digital task 208.

In some non-limiting embodiments of the present technology, the server 202 may be configured to determine respective values of the aggregate quality score associated with the first label 306 and the second label 308 in accordance with an equation:

S(y)=Σᵢ₌₁ⁿskillᵢ·I(yᵢ=y), (1)

where S(y) is the respective value of the aggregate quality metric associated with the given one of the first label 306 and the second label 308,
I(yᵢ=y) is a given instance of the given one of the first label 306 and the second label 308 within the plurality of results 404, and
skillᵢ is a given one of current values of respective quality scores of those of the current set of assessors 214 having provided the given one of the first label 306 and the second label 308—such as the current value 402 of the respective quality score associated with the given assessor 216.

However, in other non-limiting embodiments of the present technology, the server 202 may be configured to determine the respective value of the aggregate quality metric as an expected value of the given one of the first label 306 and the second label 308 in a distribution of instances thereof among the plurality of results 404. To that end, respective probability values associated with each of the instances may be determined as being the current values of the respective quality scores of respective ones of the current set of assessors 214. In other words, the server 202 may be configured to determine the respective values of the aggregate quality metric in accordance with an equation:

$$𝔼 ( y ) = {\sum }_{i = 1}^{n} {skill}_{i} \cdot I ( {y}_{i} = y ) + {\sum }_{i = 1}^{n} \frac{1 - {skill}_{i}}{L - 1} \cdot I ( {y}_{i} \neq y ) , \qquad ( 2 )$$

where S(y) is the respective value of the aggregate quality metric associated with the given one of the first label 306 and the second label 308,
I(yᵢ=y) is the given instance of the given one of the first label 306 and the second label 308 within the plurality of results 404,
skillᵢ is the given one of current values of respective quality scores of those of the current set of assessors 214 having provided the given one of the first label 306 and the second label 308—such as the current value 402 of the respective quality score associated with the given assessor 216, and
L is a number of instances of the other one of the first label 306 and the second label 308.

It should be expressly understood that, in those embodiments of the present technology where instructions associated with the given digital task 208 (such as the instructions 304 of for executing the example classification task of FIG. 3) provide more than two choices, the server 202 can be configured to determine respective values of the aggregate quality metric for each possible choice selectable by the current set of assessors 214 when executing the given digital task 208.

Thus, in some non-limiting embodiments of the present technology, the server 202 may be configured to determine the reliable result 406 as being associated with a maximum one of the respective values of the aggregate quality. In the example of FIG. 4, the reliable result 406 includes the first label 306, which means that a respective value of the aggregate quality metric associated with the first label 306 is greater than that of the second label 308.

Thus, comparing each one of the plurality of results 404 provided by the current set of assessors 214 to the reliable result 406, the server 202 may be configured to update the respective quality scores of each one of the current set of assessors 214. To that end, in accordance with certain non-limiting embodiments of the present technology, the server 202 may be configured to generate, based on the reliable result 406, a binary mask array 408. A given element of the binary mask array 408 is generated to have a value of “1” if a respective one of the plurality of results 404 corresponds to the reliable result 406, else the given element of the binary mask array 408 has a value of “0”.

Further, in some non-limiting embodiments of the present technology, the server 202 may be configured to determine difference values between respective values of the binary mask array 408 and the current values of the respective quality scores of each one of the current set of assessors 214. For example, for the current value 402 associated with the given assessor 216, the server 202 could be configured to determine a respective difference value: dᵢ=I−Qᵢ.

Accordingly, the so determined respective difference value may be used for updating the respective quality score of the given assessor 216. To that end, in some non-limiting embodiments of the present technology, the server 202 may be configured to multiply the respective difference value by a predetermined coefficient λ, and further add the resulting product to the current value 402 of the respective quality score associated with the given assessor 216.

Broadly speaking, the predetermined coefficient λ can be indicative of a changing rate of the respective quality score of the given assessor 216 in the course of executing digital tasks on the crowdsourcing application 212. For example, in case (not depicted) where the given assessor 216 has provided a respective one of a plurality of results 404 different from the reliable result 406, the predetermined coefficient λ may be defined as a penalizing rate for the given assessor 216. By contrast, the given assessor 216 has provided the respective one of the plurality of results 404 corresponding to the reliable result 406 (which is the case for the example depicted in FIG. 4), the predetermined coefficient λ may be defined as a rewarding rate for the given assessor 216.

Thus, in specific non-limiting embodiments of the present technology, the server 202 may be configured to determine an updated value of the respective quality score associated with the given assessor 216 in accordance with an equation:

skill_{i,t}←skill_{i,t-1}+λdᵢ, (3)

where skill_{i,t} is the updated value of the respective quality score of the given assessor 216;
skill_{i,t-1} is the current value 402 of the respective quality score of the given assessor 216;
dᵢ is the difference value associated with the given assessor 216; and
λ is the predetermined coefficient.

In some non-limiting embodiments of the present technology, the predetermined coefficient λ may have values from 0.1 to 1.0; however, in other non-limiting embodiments of the present technology, values of the predetermined coefficient λ less than 0.1, such as 0.001, 0.05, and 0.07, and those greater than 1.0, such as 1.5, 2, and 7, for example, can also be used.

For example, let it be assumed that the current value 402 of the respective quality score associated with the given assessor 216 is 0.8; then, given that the given assessor 216 has provided the respective result corresponding to the reliable result 406, the server 202 may be configured to determine the respective difference value as being 0.2 Further, assume a value of the predetermined coefficient λ is 0.5, then the server 202 may be configured to determine the updated value of the respective quality score of the given assessor 216 as skill_{i,t}=0.8+0.5*0.2=0.81. Thus, as the given assessor 216 has provided the respective result corresponding to the reliable result 406, the server 202 can be configured to increase the respective quality score associated therewith by a value determined in accordance with Equation (3). By contrast, as it can be appreciated, in case (not depicted) where the given assessor 216 provided the respective result different from the reliable result 406, the server 202 could be configured to decrease the respective quality score associated therewith by the same value.

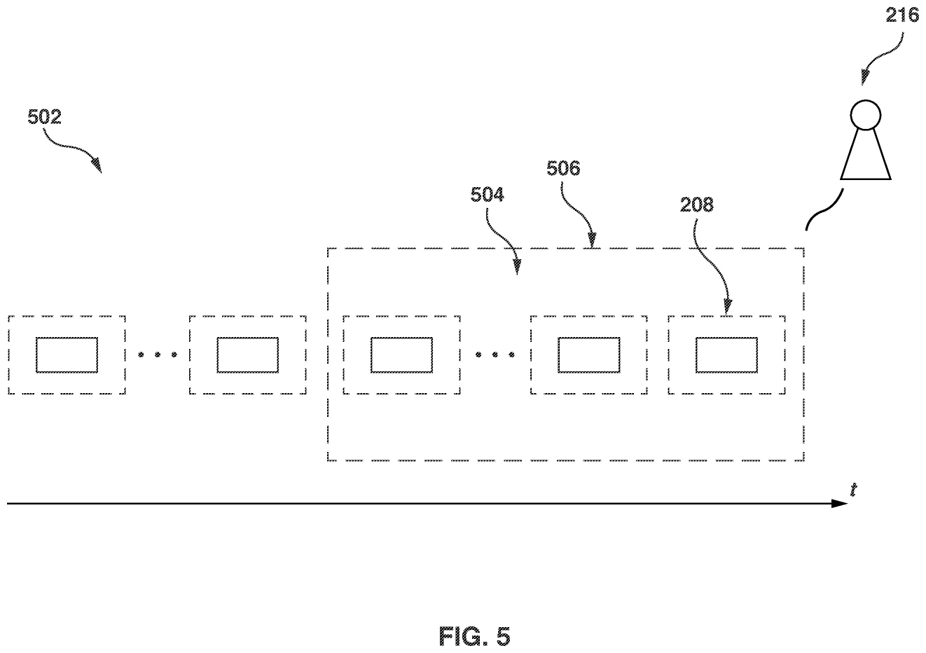

In additional non-limiting embodiments of the present technology, to update the respective quality score associated with the given assessor 216, the server 202 may further be configured to determine an average value of the respective quality score of the given assessor 216 over a certain number of past digital tasks executed thereby. With reference to FIG. 5, there is depicted a schematic diagram of a process for determining, by the server 202, an average value of the respective quality score of the given assessor 216 based on a series 504 of past digital tasks, in accordance with certain non-limiting embodiments of the present technology.

In some non-limiting embodiments of the present technology, the server 202 may be configured to retrieve, from the assessor database 204, data representative of a plurality of past digital tasks 502 executed by the given assessor 216 in the past. Further, in some non-limiting embodiments of the present technology, to select the series 504 of past digital tasks in the plurality of past digital tasks 502, the server 202 may be configured to apply a sliding window 506 having a predetermined width indicative of a number of past digital tasks in the series 504 of past digital tasks. As it may become apparent, the sliding window 506 slides ahead the plurality of past digital tasks 502 once the given assessor 216 has completed another digital task—such as the given digital task 208. Thus, the server 202 may be configured to select the series 504 including the latest past digital tasks having been completed by the given assessor 216 by a given moment in time. By so doing, the server 202 may be configured to determine a more recent average value of the respective quality score of the given assessor after execution a respective digital task submitted thereto.

Thus, in specific non-limiting embodiments of the present technology, the server 202 may be configured to determine the average value of the respective quality score associated with the given assessor 216 in accordance with an equation:

$${skill}_{i , t} ← \frac{{\sum }_{j = t - w + 1}^{t} {skill}_{i , j}}{w} , \qquad ( 4 )$$

where skill_{i,t} is the updated value of the respective quality score associated with the given assessor 216 determined based on the plurality of results 404,

skill_{i,j} is a given one of past values of the respective quality score associated with the given assessor 216, determined based on the given assessor 216 completing a respective one of the series 504 of past digital tasks; and

w is the predetermined width of the sliding window 506.

Further, according to some non-limiting embodiments of the present technology, based on the so updated values of the respective quality scores of each one of the current set of assessors 214, the server 202 may be configured to determine another set of assessors for submitting thereto subsequent digital tasks of the plurality of digital tasks 602 used for generating the labelled training data set 218 for training the MLA, as described above.

With reference to FIG. 6, there is depicted a schematic diagram of a process for determining, by the server 202, respective sets of assessors for executing subsequent digital tasks of the plurality of digital tasks 602 used for generating the labelled training data set 218, in accordance with certain non-limiting embodiments of the present technology.

Thus, in some non-limiting embodiments of the present technology, the server 202 may be configured to determine, based on the updated values of the respective quality scores of the current set of assessors 214, an updated set of assessors 604 for executing a subsequent digital task 606 of the plurality of digital tasks 602. More specifically, in response to the updated value of the respective quality score associated with the given assessor 216 being equal to or greater than a predetermined quality score threshold value (such as 0.7, 0.85, or 0.9, for example), the server 202 may be configured to include the given assessor 216 in the updated set of assessors 604 for executing the subsequent digital task 606.

However, in response to the updated value of the respective quality score associated with the given assessor 216 being lower than the predetermined quality score threshold value, the server 202 may be configured to prevent the given assessor 216 from being included in the updated set of assessors 604 for executing the subsequent digital task 606. By so doing, the server 202 may be configured to identify, within the current set of assessors 214, assessors providing lower quality results to digital tasks and further prevent such assessors from executing further ones of the plurality of digital tasks 602, which may hence improve the overall quality of the labelled training data set 218.

How the server 202 can be configured to determine the updated set of assessors 604 is not limited and may include, for example, determining the updated set of assessors 604 solely based on the current set of assessors 214; and the updated set of assessors 604 may thus include fewer assessors than the current set of assessors 214. However, in other non-limiting embodiments of the present technology, the server 202 may be configured to determine the updated set of assessors 604 further based on additional assessors from the plurality of assessors available according to the assessor database 204, thereby maintaining a constant number of assessors for executing each one of the plurality of digital tasks 602, as an example.

As it can be appreciated, the updated set of assessors 604 when executing the subsequent digital task 606 may provide and further transmit to the server 202 a subsequent plurality of results 608, which further may be included in the labelled training data set 218.

Further, according to some non-limiting embodiments of the present technology, the server 202 may be configured to determine, based on the subsequent plurality of results 608, a newly updated set of assessors (not labelled) for executing an other subsequent digital task (not labelled) of the plurality of digital tasks 602. Thus, by so doing, according to certain non-limiting embodiments of the present technology, the server 202 may be configured to determine other respective updated sets of assessors for executing other subsequent ones of the plurality of digital tasks 602 iteratively updating respective quality scores of a then current set of assessors by applying the approach described above with reference to FIGS. 4 and 5, until each one of the plurality of digital tasks 602 is completed.

Thus, according to certain non-limiting embodiments of the present technology, based on respective pluralities of results responsive to submitting each one of the plurality of digital tasks 602 to respective sets of assessors—such as the plurality of results 404 provided by the current set of assessors 214 and the subsequent plurality of results 608 provided by the updated set of assessors 604, the server 202 my be configured to generate the labelled training data set 218 for transmission thereof to the third-party server 220 for training the MLA run thereon.

### Method

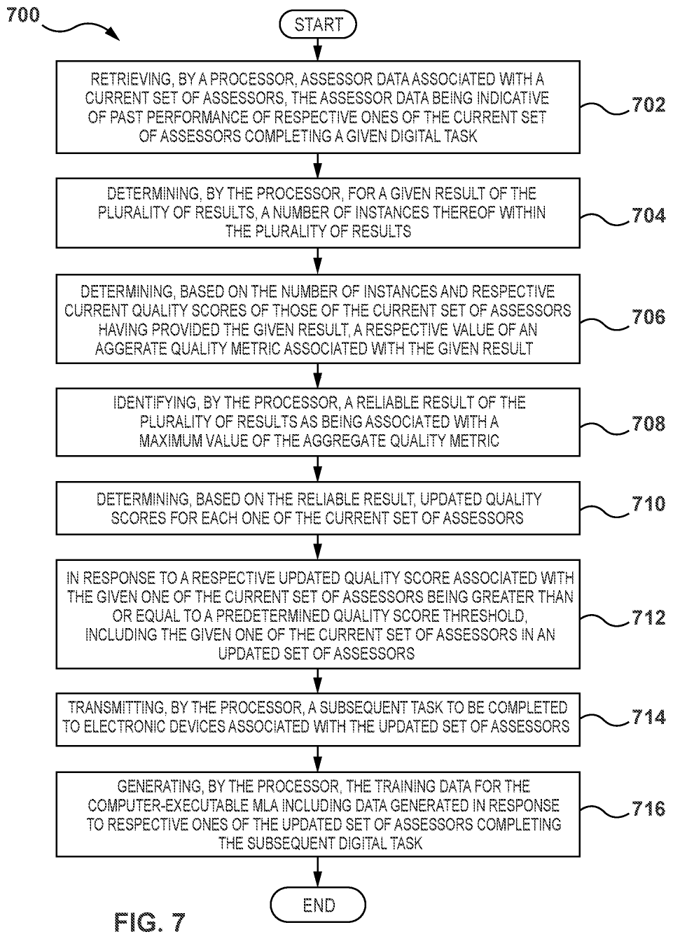

Given the architecture and the examples provided hereinabove, it is possible to execute a method for generating training data for training an MLA based on digital tasks executed by assessors, such as the labelled training data set 218 used for training the MLA on the third-party server 220, as described above. With reference to FIG. 7, there is depicted a flowchart of a method 700, according to the non-limiting embodiments of the present technology. The method 700 can be executed by the server 202 including the computer system 100.

### Step 702: Retrieving, by a Processor, Assessor Data Associated with a Current Set of Assessors, the Assessor Data being Indicative of Past Performance of Respective Ones of the Current Set of Assessors Completing a Given Digital Task

The method 700 commences at step 702 with the server 202 being configured to receive assessor data associated with a given set of assessors having executed a given task. For example, the server 202 may be configured to retrieve, from the assessor database 204, an indication of the current set of assessors 214 and data indicative of past performance thereof. As mentioned above, the data indicative of the past performance of the current set of assessors 214 may include data indicative of the current values of the respective quality scores associated therewith—such as the current value 402 of the respective quality score of the given assessor 216.

As mentioned above, in some non-limiting embodiments of the present technology, the server 202 may be configured to determine the current value 402 of the respective quality score based on control digital tasks previously submitted to the given assessor 216.

Further, in some non-limiting embodiments of the present technology, the server 202 may be configured to retrieve, from the task database 206, the indication of the given digital task 208 of the plurality of digital tasks 602 for submission thereof to the current set of assessors 214. To that end, as described above with reference to FIG. 4, the server 202 may be configured to receive the plurality of results 404 responsive to the given digital task 208. According to some non-limiting embodiments of the present technology, the server 202 may further be configured to include the plurality of results 404 in the labelled training data set 218.

The method 700 thus proceeds to step 704.

### Step 704: Determining, by the Processor, for a Given Result of the Plurality of Results, a Number of Instances Thereof within the Plurality of Results

At step 704, according to certain non-limiting embodiments of the present technology, the server 202 may be configured to determine, in the plurality of results 404, a respective number of instances of each one of the plurality of results 404. More specifically, as illustrated by the example of FIG. 4, the server 202 may be configured to determine a respective number of instances of each one of the first label 306 and the second label 308 provided by the current set of assessors 214 when executing the given digital task 208.

The method 700 hence advances to step 706.

### Step 706: Determining, Based on the Number of Instances and Respective Current Quality Scores of those of the Current Set of Assessors having Provided the Given Result, a Respective Value of an Aggerate Quality Metric Associated with the Given Result

Further, at step 706, in some non-limiting embodiments of the present the server 202 may be configured to determine for each one of the first label 306 and the second label 308, a respective value of the aggregate quality metric. As described above with reference to FIG. 4, in some non-limiting embodiments of the present technology, the server 202 may be configured to determine the respective value of the aggregate quality metric in accordance with Equation (1). In other non-limiting embodiments of the present technology, the server 202 may be configured to determine the respective value of the aggregate quality metric in accordance with Equation (2).

The method 700 thus proceeds to step 708.

### Step 708: Identifying, by the Processor, a Reliable Result of the Plurality of Results as being Associated with a Maximum Value of the Aggregate Quality Metric

At step 708, according to certain non-limiting embodiments of the present technology, based on respective values of the aggregate quality metric associated with the first label 306 and the second label 308, the server 202 may be configured to determine a reliable result in the plurality of results 404. For example, as described above with reference to FIG. 4, the server 202 may be configured to determine the reliable result as being associated with a maximum value of the aggregate quality metric—such as the reliable result 406 including the first label 306.

The method 700 hence advances to step 710.

### Step 710: Determining, Based on the Reliable Result, Updated Quality Scores for Each One of the Current Set of Assessors

At step 710, according to certain non-limiting embodiments of the present technology, based on the reliable result 406, the server 202 may be configured to update the respective quality scores.

To that end, as described above with reference to FIG. 4, the server 202 may be configured to generate, based on the reliable result 406, the binary mask arrow 408, the given element of which is 1 if a result provided by the respective one of the current set of assessors 214 corresponds to the reliable result 406, else the given element of the binary mask arrow 408 is 0.

Further, in some non-limiting embodiments of the present technology, the server 202 may be configured to determine the difference values between the respective values of the binary mask array 408 and the current values of the respective quality scores of each one of the current set of assessors 214. Thus, as described above, in some non-limiting embodiments of the present technology, based on respective difference values, the server 202 may be configured to either increase or decrease the current values of the respective quality scores of the current set of assessors 214, thereby determining respective updated values of each one thereof. In specific non-limiting embodiments of the present technology, the server 202 may be configured to determine the respective updated values of the respective quality scores in accordance with Equation (3).

In additional non-limiting embodiments of the present technology, the server 202 may further be configured to determine, for each one of the current set of assessors 214, respective average values of the respective quality scores thereof over a series of past digital tasks executed by the current set of assessors 214 in the past. For example, as described above with reference to FIG. 5, the server 202 may be configured to determine the average value of the respective quality score associated with the given assessor 216 over the series 504 of past digital tasks selected, from the plurality of past digital tasks 502 completed by the given assessor 216, based on the sliding window 506 of the predetermined width. As further described above, the server 202 may be configured to determine the average value of the respective quality score of the given assessor 216 in accordance with Equation (4).

The method 700 thus advances to step 712.

### Step 712: in Response to a Respective Updated Quality Score Associated with the Given One of the Current Set of Assessors being Greater than or Equal to a Predetermined Quality Score Threshold, Including the Given One of the Current Set of Assessors in an Updated Set of Assessors

At step 712, according to certain non-limiting embodiments of the present technology, the server 202 may be configured, based on the respective updated values of the respective quality scores of the current set of assessors 214, to generate an updated set of assessors—such as the updated set of assessors 604, as described above with reference to FIG. 6.

As noted above, according to certain non-limiting embodiments of the present technology, the server 202 may be configured to determine the updated set of assessors 604 in response to receiving, from the task database 206, an indication of the subsequent digital task 606 of the plurality of digital tasks 602.

More specifically, in response to the updated value of the respective quality score associated with the given assessor 216 being equal to or greater than the predetermined quality score threshold value (such as 0.7, 0.85, or 0.9, for example), the server 202 may be configured to include the given assessor 216 in the updated set of assessors 604 for executing the subsequent digital task 606.

However, in response to the updated value of the respective quality score associated with the given assessor 216 being lower than the predetermined quality score threshold value, the server 202 may be configured to prevent the given assessor 216 from being included in the updated set of assessors 604 for executing the subsequent digital task 606.

The method 700 thus proceeds to step 714.

### Step 714: Transmitting, by the Processor, a Subsequent Digital Task to be Completed to Electronic Devices Associated with the Updated Set of Assessors

Further, at step 714, the server 202 may be configured to submit the subsequent digital task 606 to the updated set of assessors 604 by transmitting, over the communication network 210, an indication of the subsequent digital task 606 to the respective electronic devices of each one of the updated set of assessors 604.

The method 700 thus advances to step 716.

### Step 716: Generating, by the Processor, the Training Data for the Computer-Executable MLA Including Data Generated in Response to Respective Ones of the Updated Set of Assessors Completing the Subsequent Digital Task

Finally, at step 716, the server 202 may be configured to receive the subsequent plurality of results 608 responsive to submitting the subsequent digital task 606 to the updated set of assessors 604 and further include the subsequent plurality of results 608 in the labelled training set of data 218.

As further described with reference to FIG. 6, according to some non-limiting embodiments of the present technology, the server 202 may be configured to determine, based on the subsequent plurality of results 608, the newly updated set of assessors (not labelled) for executing an other subsequent digital task (not labelled) of the plurality of digital tasks 602. Thus, by so doing, according to certain non-limiting embodiments of the present technology, the server 202 may be configured to determine other respective updated sets of assessors for executing other subsequent ones of the plurality of digital tasks 602 iteratively updating respective quality scores of the then current set of assessors by applying steps 704 to 716 described above, until each one of the plurality of digital tasks 602 is completed.

Thus, according to certain non-limiting embodiments of the present technology, based on respective pluralities of results responsive to submitting each one of the plurality of digital tasks 602 to respective sets of assessors—such as the plurality of results 404 provided by the current set of assessors 214 and the subsequent plurality of results 608 provided by the updated set of assessors 604, the server 202 my be configured to generate the labelled training data set 218 for transmission thereof to the third-party server 220 for training the MLA run thereon.

Thus, certain non-limiting embodiments of the method 700 may allow (1) determining real-time updates of respective quality scores of the given assessor 216 without having to use control digital tasks, and (2) thus automatically identifying and banning assessors providing low quality results to digital tasks, thereby iteratively redefining respective sets of assessors for executing subsequent digital tasks, which may further allow generating the training data for training the MLA of higher quality in a more efficient fashion.

The method 700 thus terminates.

It should be expressly understood that not all technical effects mentioned herein need to be enjoyed in each and every embodiment of the present technology.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

1. A computer-implemented method of generating training data for a computer-executable Machine Learning Algorithm (MLA), the training data being based on digital tasks accessible by a current set of assessors; the method being executable at a server including a processor accessible, over a communication network, by electronic devices associated with the current set of assessors, the method comprising:
retrieving, by the processor, assessor data associated with the current set of assessors, the assessor data being indicative of past performance of respective ones of the current set of assessors completing a given digital task, the assessor data including:
data indicative of a plurality of results responsive to the given digital task having been submitted to the current set of assessors; and
data indicative of respective current quality scores of each one of the current set of assessors;
determining, by the processor, for a given result of the plurality of results, a number of instances thereof within the plurality of results;
determining, based on the number of instances and respective current quality scores of those of the current set of assessors having provided the given result, a respective value of an aggerate quality metric associated with the given result;
identifying, by the processor, a reliable result of the plurality of results as being associated with a maximum value of the aggregate quality metric;
determining, based on the reliable result, updated quality scores for each one of the current set of assessors, such that:
in response to a given one of the current set of assessors having provided a respective result corresponding to the reliable result, increasing a respective current quality score associated with the given one of the current set of assessors by a predetermined value; and
in response to the given one of the current set of assessors having provided the respective result not corresponding to the reliable result, decreasing the respective current quality score by the predetermined value;
in response to a respective updated quality score associated with the given one of the current set of assessors being greater than or equal to a predetermined quality score threshold, including the given one of the current set of assessors in an updated set of assessors;
transmitting, by the processor, a subsequent digital task to be completed to electronic devices associated with the updated set of assessors; and
generating, by the processor, the training data for the computer-executable MLA including data generated in response to respective ones of the updated set of assessors completing the subsequent digital task.

2. The method of claim 1, wherein the determining the respective value of the aggregate quality metric associated with the given result is executed in accordance with an equation:
S(y)=Σᵢ₌₁ⁿskillᵢ·I(yᵢ=y),
where S(y) is the respective value of the aggregate quality metric,
I(yᵢ=y) is a given instance of the given result, and
skillᵢ is a given one of the respective current quality scores of those of the current set of assessors having provided the given result.

3. The method of claim 1, wherein the respective current quality score is indicative of a likelihood value of executing the given digital task by the given one of the current set of assessors correctly, and the determining the aggregate quality metric comprises determining an expected value of the given result in accordance with an equation:
$$𝔼 ( y ) = {\sum }_{i = 1}^{n} {skill}_{i} \cdot I ( {y}_{i} = y ) + {\sum }_{i = 1}^{n} \frac{1 - {skill}_{i}}{L - 1} \cdot I ( {y}_{i} \neq y ) ,$$
where I(yᵢ=y) is a given instance of the given result;
skillᵢ is a given one of the respective current quality scores of those of the current set of assessors having provided the given result;
I(yᵢ≠y) is a given instance of an other one of the plurality of results, which is different form the given result; and
L is a number of instances of the other one of the plurality of results different from the given result.

4. The method of claim 1, wherein the method further comprises determining the predetermined value for one of increasing and decreasing the respective current quality score based on a difference between the respective current quality score of the given one of the current set of assessors and a binary mask value, the binary mask value being 1 if the given result corresponds to the reliable result, and being 0 if the given result does not correspond to the reliable result.

5. The method of claim 4, wherein the determining the predetermined value is further based on a predetermined multiplicative coefficient indicative of a penalizing rate for each one of the current set of assessors having provided results different from the reliable result.

6. The method of claim 5, wherein determining the respective updated quality score is executed in accordance with an equation:
skill_{i,t}←skill_{i,t-1}+λdᵢ,
where skill_{i,t} is the respective updated quality score of the given one of the current set of assessors;
skill_{i,t-1} is the respective current quality score of the given one of the current set of assessors;
dᵢ is the difference between the respective current quality score and a binary value indicative of the given result provided thereby corresponding to the reliable result or not; and
λ is the predetermined multiplicative coefficient.

7. The method of claim 6, wherein the determining the respective updated quality score further comprises, for the given one of the current set of assessors, for a given last past digital task of a series of past digital tasks, the series of past digital tasks having been determined using a sliding window of a predetermined width, determining the respective updated quality score based on a last quality score associated with the given last past digital tasks and other quality scores of a remainder ones of the series of past digital tasks.

8. The method of claim 7, wherein the determining the respective updated quality score is executed in accordance with an equation:
$${skill}_{i , t} ← \frac{{\sum }_{j = t - w + 1}^{t} {skill}_{i , j}}{w} ,$$
where skill_{i,t} is the respective updated quality score associated with the given one of the current set of assessors,
skill_{i,j} is the given one of the past quality scores associated with the given one of the current set of assessors, determined based on the given one of the current set of assessors completing the respective one of the series of past digital tasks; and
w is the predetermined width of the sliding window indicative of a number of past digital tasks in the series of the past digital tasks.

9. The method of claim 1, wherein the respective current quality score has been determined based on accuracy of the given one of the current set of assessors completing a control digital task.

10. The method of claim 1, further comprising:
retrieving, by the processor, data including a plurality of subsequent results responsive to the subsequent digital task having been submitted to the updated set of assessors
determining, by the processor, for a given subsequent result of the plurality of subsequent results, a second number of instances of the given subsequent result within the plurality of subsequent results;
determining, based on the second number of instances and respective updated quality scores of those of the updated set of assessors having provided the given subsequent result, a respective value of a second aggerate quality metric associated with the given subsequent result; and
identifying, by the processor, a reliable subsequent result of the plurality of subsequent results as being associated with a maximum value of the second aggregate quality metric.

11. The method of claim 10, further comprising determining, based on the reliable subsequent result, newly updated quality scores for each one of the updated set of assessors, such that:
in response to a given one of the updated set of assessors having provided a respective subsequent result corresponding to the reliable subsequent result, increasing a respective updated quality score associated with the given one of the updated set of assessors by the predetermined value; and
in response to the given one of the updated set of assessors having provided the respective subsequent result not corresponding to the reliable subsequent result, decreasing the respective updated quality score by the predetermined value;
in response to a newly updated quality score associated with the given one of the updated set of assessors being greater than or equal to the predetermined quality score threshold, including the given one of the updated set of assessors in a newly updated set of assessors;
transmitting, by the processor, an other subsequent digital task to be completed to electronic devices associated with the newly updated set of assessors; and
generating, by the processor, the training data for the computer-executable MLA including data generated in response to respective ones of the newly updated set of assessors completing the other subsequent digital task.

12. The method of claim 11, wherein the determining the newly updated quality scores for each one of the updated set of assessors for determining the newly updated set of assessors is triggered by receipt, by the server, the other subsequent digital task.

13. A system for generating training data for a computer-executable Machine Learning Algorithm (MLA), the training data being based on digital tasks accessible by a current set of assessors; the system comprising a server including:
a processor accessible, over a communication network, by electronic devices associated with the current set of assessors;
a non-transitory computer-readable memory storing instructions;
the processor, upon executing the instructions, being configured to:
retrieve assessor data associated with the current set of assessors, the assessor data being indicative of past performance of respective ones of the current set of assessors completing a given digital task, the assessor data including:
data indicative of a plurality of results responsive to the given digital task having been submitted to the current set of assessors; and
data indicative of respective current quality scores of each one of the current set of assessors;
determine, for a given result of the plurality of results, a number of instances thereof within the plurality of results;
determine, based on the number of instances and respective current quality scores of those of the current set of assessors having provided the given result, a respective value of an aggerate quality metric associated with the given result;
identify a reliable result of the plurality of results as being associated with a maximum value of the aggregate quality metric;
determine, based on the reliable result, updated quality scores for each one of the current set of assessors, such that:
in response to a given one of the current set of assessors having provided a respective result corresponding to the reliable result, increase a respective current quality score associated with the given one of the current set of assessors by a predetermined value; and
in response to the given one of the current set of assessors having provided the respective result not corresponding to the reliable result, decrease the respective current quality score by the predetermined value;
in response to a respective updated quality score associated with the given one of the current set of assessors being greater than or equal to a predetermined quality score threshold, include the given one of the current set of assessors in an updated set of assessors;
transmit a subsequent digital task to be completed to electronic devices associated with the updated set of assessors; and
generate the training data for the computer-executable MLA including data generated in response to respective ones of the updated set of assessors completing the subsequent digital task.

14. The system of claim 13, wherein the processor is configured to determine the respective value of the aggregate quality metric associated with the given result in accordance with an equation:
S(y)=Σᵢ₌₁ⁿskillᵢ·I(yᵢ=y),
where S(y) is the respective value of the aggregate quality metric,
I(yᵢ=y) is a given instance of the given result, and
skillᵢ is a given one of the respective current quality scores of those of the current set of assessors having provided the given result.

15. The system of claim 13, wherein the respective current quality score is indicative of a likelihood value of executing the given digital task by the given one of the current set of assessors correctly, and the processor is configured to determine the aggregate quality metric as an expected value of the given result in accordance with an equation:
$$𝔼 ( y ) = {\sum }_{i = 1}^{n} {skill}_{i} \cdot I ( {y}_{i} = y ) + {\sum }_{i = 1}^{n} \frac{1 - {skill}_{i}}{L - 1} \cdot I ( {y}_{i} \neq y ) ,$$
where I(yᵢ=y) is a given instance of the given result;
skillᵢ is a given one of the respective current quality scores of those of the current set of assessors having provided the given result;
I(yᵢ≠y) is a given instance of an other one of the plurality of results, which is different form the given result; and
L is a number of instances of the other one of the plurality of results different from the given result.

16. The system of claim 13, wherein the processor is further configured to determine the predetermined value for one of increasing and decreasing the respective current quality score based on a difference between the respective current quality score of the given one of the current set of assessors and a binary mask value, the binary mask value being 1 if the given result corresponds to the reliable result, and being 0 if the given result does not correspond to the reliable result.

17. The system of claim 16, wherein the processor is further configured to determine the predetermined value based on a predetermined multiplicative coefficient indicative of a penalizing rate for each one of the current set of assessors having provided results different from the reliable result.

18. The system of claim 17, wherein the processor is configured to determine the respective updated quality score in accordance with an equation:
skill_{i,t}←skill_{i,t-1}+λdᵢ,
where skill_{i,t} is the respective updated quality score of the given one of the current set of assessors;
skill_{i,t-1} is the respective current quality score of the given one of the current set of assessors;
dᵢ is the difference between the respective current quality score and a binary value indicative of the given result provided thereby corresponding to the reliable result or not; and
λ is the predetermined multiplicative coefficient.

19. The system of claim 18, wherein to determine the respective updated quality score, the processor is further configured, for the given one of the current set of assessors, for a given last past digital task of a series of past digital tasks, the series of past digital tasks having been determined using a sliding window of a predetermined width, to determine the respective updated quality score based on a last quality score associated with the given last past digital tasks and other quality scores of a remainder ones of the series of past digital tasks.

20. The system of claim 19, wherein the processor is further configured to determine the respective updated quality score in accordance with an equation:
$${skill}_{i , t} ← \frac{{\sum }_{j = t - w + 1}^{t} {skill}_{i , j}}{w} ,$$
where skill_{i,t} is the respective updated quality score associated with the given one of the current set of assessors,
skill_{i,j} is the given one of the past quality scores associated with the given one of the current set of assessors, determined based on the given one of the current set of assessors completing the respective one of the series of past digital tasks; and
w is the predetermined width of the sliding window indicative of a number of past digital tasks in the series of the past digital tasks.
